(19) United States
(12) Patent Application Publication
(10) Pub. No.: US 2011/0128217 A1
(43) Pub. Date: Jun. 2, 2011

(54) DISPLAY SYSTEM CONTROLLING DISPLAY DATA USING REMOTE CONTROLLER HAVING LANGUAGE CONVERSION KEY

(76) Inventor: Jin Gil Cha, Anyang Si (KR)

(21) Appl. No.: 12/628,981

(22) Filed: Dec. 1, 2009

(30) Foreign Application Priority Data
Dec. 1, 2009 (KR) 10-2009-0117522

(51) Int. Cl. G09G 5/00

(52) U.S. Cl. 345/156

(57) ABSTRACT

Disclosed herein is a display system controlling display of data on a display according to input of a user through a remote controller. The display system includes the remote controller, a language conversion key for converting the displayed fundamental alphabets into modified alphabets, and a transmitter; and the display including a receiver, an LED module, and a controller for analyzing the control signal received by the receiver, selecting one of modified alphabets belonging to a modified alphabet group, which corresponds to a fundamental alphabet being expressed by the LED module, according to input through the language conversion key and controlling display of the selected modified alphabet through the LED module. Accordingly, a user can easily change a displayed language through the language conversion key.

### BACKGROUND OF THE INVENTION

1. Field of the Invention

The present invention relates to a display system capable of allowing a user to change a language corresponding to displayed alphabets through a language conversion key included in a remote controller.

2. Background of the Related Art

Various letters and/or images are displayed through a display rather than a signboard or a placard nowadays. The display can achieve higher public relation effect than a conventional signboard or placard because the display can change data displayed thereon whenever necessary. However, it is required to use a computer connected to the display in order to change data displayed on the display, and thus a user who is not accustomed to using the computer is restricted to use the display.

To solve this problem, a remote controllable display has come out and appealed to people recently. A user can input desired letters using a remote controller to easily display the letters on the display.

Meanwhile, utilization of displays used in a multi-culture multi-language society such as America can be maximized when the displays can display various languages in addition to English.

However, the conventional remote controllable display has difficulty in using various menus although it is conveniently used. Accordingly, the conventional remote controllable display is not suitable to express various languages.

Furthermore, conventional displays have difficulty in displaying letters in languages other than English, and thus they cannot be used for users who do not know the languages other than English.

### SUMMARY OF THE INVENTION

Accordingly, the present invention has been made in view of the above-mentioned problems occurring in the prior art, and it is a primary object of the present invention to provide a display system for allowing a user to easily convert English alphabets displayed on a remote controllable display into alphabets of languages other than English.

To accomplish the above object of the present invention, according to the present invention, there is provided a display system controlling display of data on a display according to input of a user through a remote controller 110, which comprises the remote controller 110 including a letter input unit 210 having a plurality of buttons for displaying fundamental alphabets on the display, a language conversion key 111 for converting the displayed fundamental alphabets into modified alphabets, and a transmitter 230 for transmitting a control signal according to input of the user through the letter input unit or the language conversion key to the display; and the display including a receiver 240 for receiving the control signal transmitted from the transmitter 230, an LED module 260 for expressing a letter corresponding to the received control signal, and a controller 250 for analyzing the control signal received by the receiver 240, selecting one of modified alphabets belonging to a modified alphabet group, which corresponds to a fundamental alphabet being expressed by the LED module 260, according to input through the language conversion key 111 and controlling display of the selected modified alphabet through the LED module 260.

The modified alphabet group may include one or more modified alphabets which are obtained by adding at least one dot or stroke to the fundamental alphabets and change the fundamental alphabets.

The controller 250 may sequentially change the modified alphabet belonging to the modified alphabet group, which corresponds to the displayed fundamental alphabet, in a predetermined order and sequentially display the changed modified alphabets when the language conversion key 111 is pressed multiple times.

The fundamental alphabets may be English alphabets and the modified alphabets may be alphabets of one of Spanish, German, Italian, Russian, Latin, Greek and Turkish based on the English alphabets and correspond to the fundamental alphabets.

Accordingly, the present invention can easily display alphabets of languages other than English on a display based on English alphabets even when a user does not know languages other than English, such as Spanish.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 shows an example of changing display data according to an embodiment of the present invention;

FIG. 2 shows a configuration of a display system according to an embodiment of the present invention; and

FIG. 3 shows an exemplary alphabet mapping table according to an embodiment of the present invention.

### DETAILED DESCRIPTION OF THE PREFERRED EMBODIMENT

The present invention will now be described more fully with reference to the accompanying drawings, in which exemplary embodiments of the invention are shown. The scope of the present invention should not be limited to the description of the embodiment, but defined by the accompanying claims and equivalents thereof. It is to be understood that the phraseology and terminology employed herein is for the purpose of description and should not be regarded as limiting. Use of singular and plural is solely for the sake of illustration and is not to be interpreted as limiting. Except where the contrary is explicitly noted, the plural may be replaced by the singular and vice-versa. The terms “comprising,” “having,” “including,” and “containing” are to be construed as open-ended terms (i.e., meaning “including, but not limited to,”) unless otherwise noted.

A display system according to the present invention includes a remote controller and a display. A user can remotely input data to be displayed on the display using the remote controller. The display includes an LED module having a plurality of LEDs which may be turned on to express various letters. Further, the display according to the present invention can be implemented in various manners, such as an RGB 3-color display and a full-color display. Detailed descriptions of methods of implementing the display and the remote controller, which are well-known in the art, are omitted in the specification.

In the specification, fundamental alphabets mean English alphabets “a, b, c, d, . . . ” and modified alphabets mean alphabets of other languages, which correspond to the fundamental alphabets. For example, a modified alphabet corresponding to the fundamental alphabet “a” may be “à”, “á”, “â”, “ã”, “ä” or “å”. That is, the modified alphabets are obtained by adding one or more dot or stroke to corresponding fundamental alphabets and change the fundamental alphabets. A set of these modified alphabets is referred to as a modified alphabet group.

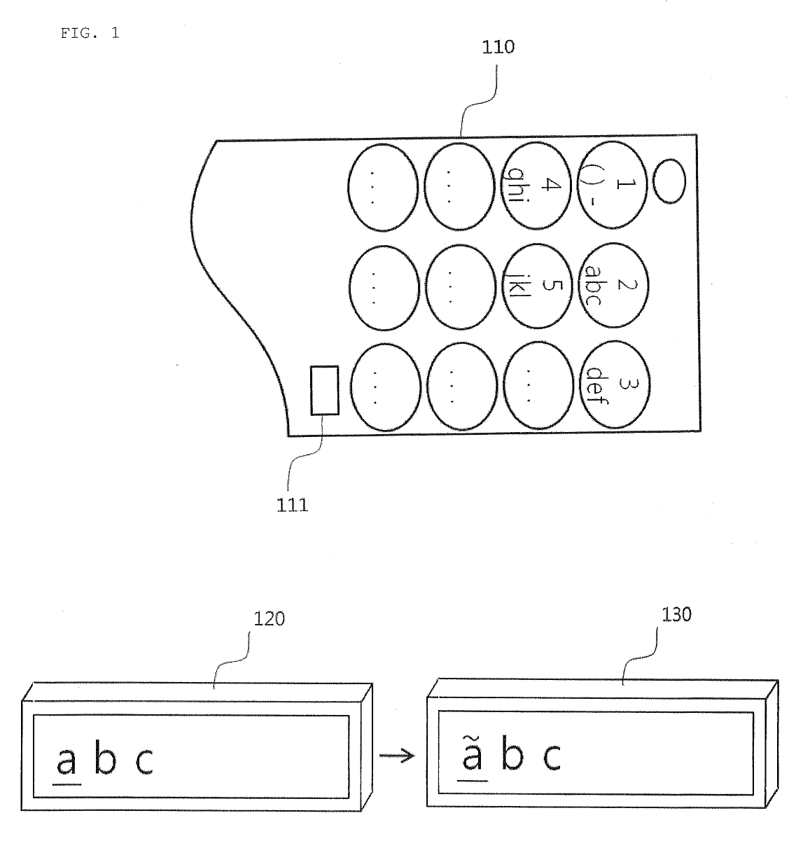

Change of a language corresponding to data displayed on the display according to an embodiment of the present invention will now be explained in detail with reference to FIG. 1.

FIG. 1 shows an example of changing display data according to an embodiment of the present invention. It is assumed that a user displays “abc” on the display. Here, a cursor is displayed on the display to indicate a letter input state. The position of the cursor can be controlled according to input of a user.

Referring to FIG. 1, the display displays “abc” 120 according to input of the user. Here, the user may want to change “a” into a letter in a language other than English. In this case, the user can change “a” into “ã” by applying input through the language conversion key 111 of the remote controller 110 to display “ãbc” 130 on the display. That is, the data 120 displayed on the display is changed to data 130, as shown in FIG. 1.

As described above, the display system according to the present invention can change an alphabet displayed on the display to alphabets in various languages only with input through the language conversion key 111 of the remote controller 110.

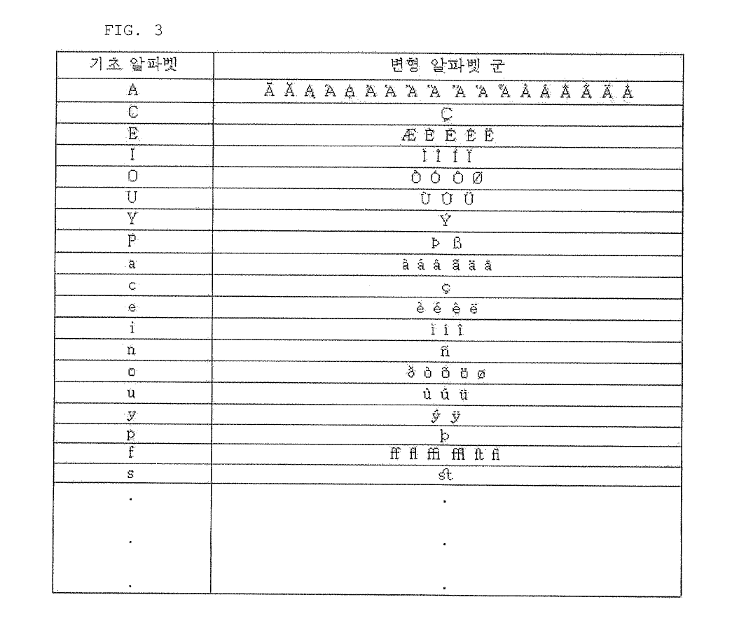

If the user re-inputs the language conversion key 111 without moving the curser, the display can display “à” instead of “ã”, which is not shown in FIG. 1. The display system according to the present invention sequentially changes a displayed alphabet to corresponding alphabets by only inputting the language conversion key 111. Here, language conversion may be performed through an alphabet mapping table. The alphabet mapping table maps English alphabets to modified alphabets corresponding to the English alphabets, which will be described in detail later with reference to FIG. 3.

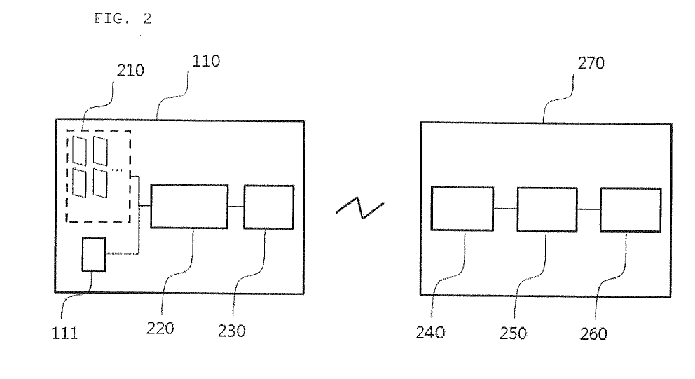

FIG. 2 shows a configuration of the display system according to an embodiment of the present invention. Referring to FIG. 2, the display system includes the remote controller 110 and a display 270. The remote controller 110 includes a letter input unit 210, the language conversion key 111, a remote controller control unit 220, and a transmitter 230.

The letter input unit 210 includes a plurality of buttons for displaying the fundamental alphabets on the display 270. Specifically, the letter input unit 210 may be implemented as a plurality of buttons corresponding to fundamental alphabets, such as buttons of a cellular phone.

A user may input fundamental alphabets to be displayed on the display 270 using the letter input unit 210.

The language conversion key 111 is a button attached to the remote controller 110 and is used to change a displayed fundamental alphabet to a corresponding modified alphabet. The display system of the present invention additionally includes the language conversion key 111, distinguished from a conventional remote controller. Accordingly, the display system of the present invention can allow a user to easily change a language to another language alphabet by alphabet by pressing a single button (language conversion key 111).

When a conventional display system is used in a multi-culture country such as America, for example, users may want to display various languages including Spanish in addition to English on a display. To display a language other than English, for example, Spanish, on the display, however, it is required to set Spanish through a menu and input Spanish alphabets in a Spanish mode in which all menus are written in Spanish. Further, the letter input unit of the remote controller of the conventional display system should display alphabets of all of languages that can be expressed because the users require to know which buttons correspond to buttons for inputting alphabets of languages other than English.

In the display system of the present invention, however, it is only required to map the letter input unit 210 of the remote controller 110 to English alphabets. Further, users do not require to know languages to be displayed.

When a user knows only spelling of greetings in Spanish, for example, the user can display the Spanish greetings on the display 270 by inputting English alphabets (fundamental alphabets) similar to the Spanish spelling and then pressing the language conversion key 111.

The remote controller 110 may include various buttons such as a power on/off button, an image or effect input button and a menu button for selecting a letter input mode in addition to the letter input unit 210 and the language conversion key 111, which is similar to a remote controller for controlling the conventional display so that detailed explanation thereof is omitted.

The remote controller control unit 220 generates a control signal according to input through the letter input unit 210 and/or the language conversion key 111 and transmits the control signal to the display 270 through the transmitter 230 which will be explained later. While the remote controller control unit 220 simply generates the control signal and transmits the control signal to the transmitter 230 in the specification, the remote controller control unit 220 may generate a control signal for conversion of a fundamental alphabet to a corresponding modified alphabet, which is performed by a controller 250 of the display 270, according to input through the language conversion key 111 and transmit the control signal to the display 270 through the transmitter 230.

Here, the transmitter 230 may be implemented as a communication module that transmits a control signal to the display 270 through a near field communication method such as IR communication, Bluetooth communication, RF communication, etc.

The remote controller control unit 220 and the transmitter 230 may be implemented similarly to those of a conventional remote controller so that detailed explanation thereof is omitted.

The display 270 includes a receiver 240, the controller 250 and an LED module 260.

The receiver 240 receives the control signal transmitted from the transmitter 230 of the remote controller 110. The receiver 240 is required to employ a communication method corresponding to that of the transmitter 230. That is, the receiver 240 should employ an IR communication mode if the transmitter 230 of the remote controller 110 employs the IR communication mode. Further, the receiver 240 may employ one or more communication modes for performing various remote control operations of the remote controller 110. Even in this case, the receiver 240 must employ a plurality of communication modes including the communication mode employed by the transmitter 230 of the remote controller 110.

The LED module 260 expresses a letter corresponding to the control signal received through the receiver 240. As described above, the LED module 260 includes a plurality of LEDs and may be implemented in a variety of forms including a 3-color display and a full-color display.

The controller 250 analyzes the control signal received through the receiver 240, selects one of modified alphabets belonging to a modified alphabet group, which corresponds to a fundamental alphabet being expressed by the LED module 260, according to input through the language conversion key 111 and displays the selected modified alphabet.

Specifically, the controller 250 analyzes the control signal received by the receiver 240. Here, if the received control signal corresponds to input through the language conversion key 111, the controller 250 confirms a fundamental alphabet currently indicated by the cursor. Then, the controller 250 extracts a modified alphabet corresponding to the fundamental alphabet indicated by the cursor. Here, the controller 250 may use the alphabet mapping table, which will be explained below with reference to FIG. 3.

The controller 250 changes the fundamental alphabet to the corresponding modified alphabet and displays the modified alphabet. Here, when the control signal is received again according to input through the language conversion key 111 of the remote controller 110, the controller 250 can change the corresponding modified alphabet to another modified alphabet that belongs to the same modified alphabet group to which the corresponding modified alphabet belongs.

FIG. 3 shows an exemplary alphabet mapping table according to an embodiment of the present invention. Referring to FIG. 3, the alphabet mapping table matches the fundamental alphabets to modified alphabet groups respectively corresponding to the fundamental alphabets.

For example, a fundamental alphabet A is matched to a modified alphabet group including modified alphabets “Ā”, “\check{A}”, “′A”, “ [symbol] ” and “′A”. Further, a fundamental alphabet “U” is matched to a modified alphabet group including modified alphabets “Ù”, “Û” and “Ü”.

The controller 250 included in the display 270 can change a fundamental alphabet to a modified alphabet corresponding thereto using the alphabet mapping table when a user presses the language conversion key 111.

Specifically, when the user presses the language conversion key 111, the controller 250 confirms a fundamental alphabet currently indicated by the cursor. Then, the controller 250 confirms a modified alphabet group corresponding to the confirmed fundamental alphabet using the alphabet mapping table. Subsequently, the controller 250 changes the fundamental alphabet to one of modified alphabets belonging to the confirmed modified alphabet group and displays the modified alphabet.

When the user repeatedly presses the language conversion key 111, the controller 250 can sequentially change and display a plurality of modified alphabets belonging to the corresponding modified alphabet group to allow the user to select an alphabet in a desired language.

The alphabet mapping table shown In FIG. 3 is exemplary and the present invention is not limited thereto.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A display system controlling display of data on a display according to input of a user through a remote controller, comprising:
the remote controller including a letter input unit having a plurality of buttons for displaying fundamental alphabets on the display, a language conversion key for converting the displayed fundamental alphabets into modified alphabets, and a transmitter for transmitting a control signal according to input of the user through the letter input unit or the language conversion key to the display; and
the display including a receiver for receiving the control signal transmitted from the transmitter, an LED module for expressing a letter corresponding to the received control signal, and a controller for analyzing the control signal received by the receiver, selecting one of modified alphabets belonging to a modified alphabet group, which corresponds to a fundamental alphabet being expressed by the LED module, according to input through the language conversion key and controlling display of the selected modified alphabet through the LED module.

2. The display system of claim 1, wherein the modified alphabet group includes one or more modified alphabets which are obtained by adding at least one dot or stroke to the fundamental alphabets and change the fundamental alphabets.

3. The display system of claim 1, wherein the controller sequentially changes the modified alphabet belonging to the modified alphabet group, which corresponds to the displayed fundamental alphabet, in a predetermined order and sequentially displays the changed modified alphabets when the language conversion key is pressed multiple times.

4. The display system of claim 1, wherein the fundamental alphabets are English alphabets and the modified alphabets are alphabets of one of Spanish, German, Italian, Russian, Latin, Greek and Turkish based on the English alphabets and correspond to the fundamental alphabets.
